(19) United States
(12) Patent Application Publication
(10) Pub. No.: US 2013/0077092 A1
(43) Pub. Date: Mar. 28, 2013

(54) SUBSTRATE SURFACE DEFECT INSPECTION METHOD AND INSPECTION DEVICE

(71) Applicants: Hideaki SASAZAWA, Kamisato (JP); Shigeru SERIKAWA, Kamisato (JP); Kiyotaka HORIE, Kamisato (JP); Yu YANAKA, Kamisato (JP)

(72) Inventors: Hideaki SASAZAWA, Kamisato (JP); Shigeru SERIKAWA, Kamisato (JP); Kiyotaka HORIE, Kamisato (JP); Yu YANAKA, Kamisato (JP)

(73) Assignee: Hitachi High-Technologies Corporation

(21) Appl. No.: 13/565,833

(22) Filed: Aug. 3, 2012

(30) Foreign Application Priority Data
Sep. 28, 2011 (JP) 2011-213008

(51) Int. Cl. G01N 21/956

(52) U.S. Cl. 356/237.5

(57) ABSTRACT

A substrate surface inspection device includes an inspection optical system irradiating at least one light onto a substrate, which is an inspection target and carried on a turnable stage, and having at least one detector detecting reflected or scattered light from the substrate, a detector processing the signals, which are outputted from the at least one detector and A/D converted, and detecting a defect on the substrate, an output calculator performing scattered light simulation on a defect detection model and estimating a plurality of detector outputs; and a classifier constructor constructing a classifier by mechanical learning of a rule base, wherein the classifier constructor is adapted to present collection of a necessary actual defect sample on the basis of the classifier obtained by scattered light simulation, and construct the classifier under necessary and sufficient conditions.

### BACKGROUND OF THE INVENTION

The present invention relates to a method for detecting a surface defect on a substrate and a device therefor and, more particularly, to a substrate surface defect inspection method suitable for detecting a linear defect on a surface of a magnetic disc substrate and an inspection device therefor.

In a device inspecting a surface of a magnetic disc substrate, there is a need for classifying a detected defect for the purpose of contributing it to advancement of process management and improvement of a process. A detection optical system of device inspecting the surface of the magnetic disc substrate is typically equipped with a plurality of detectors. The classifying of the defect is carried out on the basis of detection signals from these detectors.

As a conventional device inspecting a surface of a magnetic disc, for example, Patent Literature 1 (JP-A1 No. 2000-180376) discloses a device inspecting a surface of a magnetic disc in which a laser is irradiated to the magnetic disc that is an inspection target, reflected light and scattered light from the surface of the magnetic disc are received by a plurality of detectors, and a micro defect is classified according to light receiving conditions of the respective detectors. Moreover, a plane continuity of the detected micro defect is judged, and classifying of a length and size of the detected defect, of a linear defect, and of a massive defect is performed.

Moreover, Patent Literature 2 (JP-A1 No. 9-26396) describes that a surface structure of a target is modeled and defect detection conditions are determined on the basis of a distribution in scattered light simulation. Moreover, Patent Literature 3 (JP-A1 No. 2008-82821) describes that, when learning data is presented in classification of a defect on a rule base, classification performance is prioritized in a classifier construction process to establish a rule.

However, in order to obtain desired classification performance, it is necessary to suitably set respective judgment conditions. Moreover, classified defect samples which are necessary therefor are required to be previously prepared. Moreover, in addition to complexities of the judgment conditions, there is a limitation in the preparation of a great quantity of classified defect samples. Therefore, the judgment conditions are set on the basis of only representative defect samples, so that there is a problem that sufficient verification cannot be always performed.

### SUMMARY OF THE INVENTION

As described above, in order to achieve high-speed inspection and defect classification in the optical inspection of the magnetic disc, there is employed the method, in which the shape of the defect is presumed on the basis of a light intensity distribution of the scattered light from the defect and the classification is performed. In order to achieve desired classification performance under a limitation on the sensitivities of sensors, the number of the sensors to be arranged, and the like, complex judgment conditions are required. Particularly, regarding a micro defect that has a size equivalent to or lesser than the spatial resolution of the sensor, it is difficult to judge a defect type from shape information that can be detected.

For example, according to the classification method for the defect, which is described in the Patent Literature 1, the judgment is made by comparing respective sensor signal values with set values for them in the classification of the micro defect. In a determining method for the set values affecting the classification performance, the set values are set using known defect samples. However, consideration is not paid to the classification performance and the classification limitation.

Moreover, the invention described in the Patent Literature 2 is limited to a case where a defect has a simple shape, which can be approximated by the scattered light simulation, such as a defect Rayleigh scattering) that is considerably small with respect to a detection wavelength, and a defect that has a globular shape or an evenly convex shape. There is a problem in a great divergence between them and actual defects having various shapes and sizes.

Moreover, in the classifier construction method described in the Patent Literature 3, setting of the respective conditions is performed while confirming the classification performance using an actual defect (learning data) previously classified by a person. However, no consideration is paid to how to collect actual defect data (learning data) that are necessary.

The learning data is important for improving and verifying the performance of the defect classification. The leaning data in this case is a data in which sensor outputs for the target sample in the inspection device are obtained and a correct defect type is ascertained. Generally, in order to judge the correct defect type, observation is required to be performed by a measurement means having a resolution higher than that of the inspection device, or a measurement means depending on an entirely distinct measurement principle, and time and cost are taken. For example, in the defect inspection of the magnetic disc, a microscope of 50 magnifications or more, a scanning electron microscope (SEM), an atomic force microscope (AFM), etc. are used.

An object of the present invention solve the problems of the foregoing prior art, and is to efficiently provide setting conditions for higher classification performance.

In order to achieve the above-mentioned object, according to the present invention, there is provided a device for inspecting a defect on a substrate, which comprises a turnable stage means on which a substrate that is an inspection target is carried; an inspection optical system including one or more illumination sources irradiating light onto the substrate carried on the stage means, and one or more detectors detecting reflected or scattered light from the substrate onto which the light is irradiated by the illumination sources; an A/D converter means amplifying and A/D converting signals outputted from the one or more detectors of the inspection optical system; a defect detection means processing the signals, which are outputted from the one or more detectors and converted by the A/D converter, and detecting a defect on the substrate; an output calculation means performing scattered light simulation on a defect detection model and estimating a plurality of detector outputs; and a classifier constructing means constructing a classifier by mechanical learning of a rule base, wherein the classifier constructing means is capable of presenting collection of a necessary actual defect sample on the basis of the classifier obtained by scattered light simulation, and of constructing the classifier under necessary and enough conditions.

Moreover, in order to achieve the above-mentioned object, according to the present invention, there is provided a method for inspecting a defect on a surface of a substrate, which comprises the step of irradiating illumination light from one or more illumination sources onto a substrate carried on a turnable stage, while turning the turnable state; detecting, by one or more detectors, reflected and scattered light from the substrate onto which the light is irradiated by the one or more illumination sources; amplifying and A/D converting signals that are outputted from the one or more detectors that detect the reflected or scattered light from the substrate; processing the signals, that are outputted from the one or more detectors and A/D converted, and detecting a defect on the substrate, and detecting a defect on the substrate; performing scattered light simulation on a defect detection model and estimating a plurality of detector outputs; and constructing a classifier by mechanical learning of a rule base, wherein the step of constructing a classifier includes the step of presenting collection of a necessary actual defect sample on the basis of the classifier obtained by simulation, and constructing the classifier under necessary and enough conditions.

According to the present invention, classification performance is previously presented by the simulation, whereby there are provided effects of allowing a classification limitation to become clear, of improving the classification performance, of effectively collecting an actual sample date to be verified, and of shortening conditions-setting time.

Moreover, according to the present invention, a type of a defect to be produced is grasped, whereby it is possible to limit a portion which becomes the cause of generation of the defect in a manufacturing stage

### BRIEF DESCRIPTION OF THE DRAWINGS

FIG. 1 is a block diagram illustrating an entire schematic structure of a surface defect inspection device according to an embodiment of the present invention;

FIG. 2 is a view which illustrates respective defect models obtained in a simulation system and an example of a calculation result of a scattered light distribution;

FIG. 3 is a view which illustrates combinations of various defects and expected outputs of detectors which are provided in the simulation system;

FIG. 4 is a view which illustrates an example of calculation of feature values;

FIG. 5 is a view which illustrates an example of a decision tree classifier constructed by a classification algorism;

FIG. 6 is a view which illustrates an example of a state of a distribution of defect species obtained by simulation in a feature value parameter space and actually detected defects;

FIG. 7 is a view which illustrates an example of a classification result obtained by an embodiment; and

FIG. 8 is a flow chart which illustrates a flow of a process for detecting and classifying a defect according to the embodiment of the present invention.

### DETAILED DESCRIPTION OF EMBODIMENT

An embodiment of the present invention will be explained with reference to the drawings.

### Embodiment

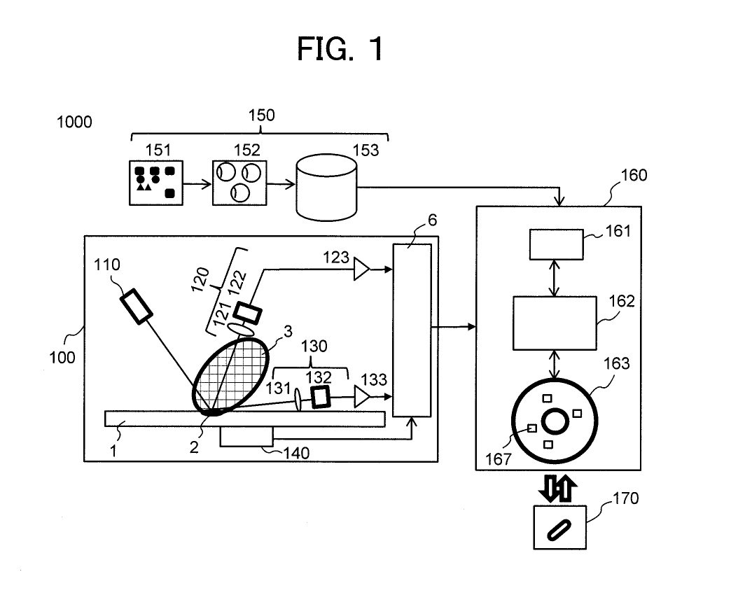

First referring to FIG. 1, there is illustrated a schematic structure of a magnetic disc surface defect inspection device 1000. The magnetic disc surface defect inspection device 1000 includes an illumination detection optical system (hereinafter referred to as “optical system”) 100, a defect output simulation system (hereinafter referred to as “simulation system”) 150, a defect classifying and processing system 160, and a defect observation system 170.

The optical system 100 includes one illumination means and two detection means. The illumination means is an illumination means 110 that irradiates a laser from a high angle direction onto a surface of a magnetic disc that is a sample 1. The two detection means includes a high angle detection means 120 and a low angle detection means 130.

The high angle detection means 120 includes a lens 121 for collecting reflected and scattered light containing a regularly reflected light advancing in a high angle direction in a distribution 3 of light which is irradiated by the first illumination means 110 and reflected and scattered from the surface of the sample 1, and a high angle detector 122 detecting the light collected by the light collecting lens 121.

The low angle detection means 130 includes a lens 131 for collecting reflected and scattered light containing a regularly reflected light advancing in a low angle direction in the distribution 3 of light which is irradiated by the first illumination means 110 and reflected and scattered from the surface of the sample 1, and a low angle detector 132 detecting the light collected by the light collecting lens 131.

Signals which are outputted at the high angle detector 122 and the low angle detector 132 are respectively amplified and A/D converted by A/D converters 123, 133, and inputted into a signal processing device 6.

The signal processing device 6 has a function of receiving a position signal for controlling the position of the sample 1 from a stage means 140, in addition to a function of receiving the A/D converted signals which are outputted at the high angle detectors 122 and the low angle detector 132.

The simulation system 150 includes a defect model generation means 151 generating an optically defect model, an output calculation means 152 calculating a distribution of reflected light and scattered light with respect to the generated defect model and estimating a plurality of detector outputs in detector models equivalent to the optical system 100, and a data base 153 storing combinations of respective defects and expected detector outputs corresponding thereto.

The defect classifying and processing system 160 is connected to the signal processing device 6 of the optical system 100 and the defect signal output data base 153 of the simulation system 150 and includes a user interface which is comprised of a defect classifier 161, a feature value displaying screen 162, a defect position displaying screen 163, and the like.

Moreover, the magnetic disc surface defect inspection device 1000 has a function of observing, by a magnification detection means such as a microscope in the defect observation system 170, the defect of the position which is presented by the defect position displaying screen 163.

With the above-mentioned structure, the sample 1 in a state of being carried on the stage means 140 is turned around a normal direction of the surface of the sample 1 as a turning center and starts to move at a regular speed in one direction at a right angle relative to the normal direction.

In this state, a laser is irradiated from the illumination means 110 of the optical system 100 onto a front surface of the sample 1 turning on the stage means 140. The light which is irradiated onto a defect 2 on the front surface of the sample 1 forms a light distribution 3 of reflected and scattered light, in which light incident on the light collecting lens 121 is collected and detected by the high angle detector 122. Moreover, light incident on the light collecting lens 131 in the light distribution 3 of the reflected and scatter light is collected and detected by the low angle detector 132. Such inspection is performed with respect to an inner peripheral portion from an outer peripheral portion of the sample 1 by causing the sample 1 to be translatorily moved while turning the sample 1, whereby it is possible to inspect an entire front surface of the sample 1. Moreover, the sample 1 is inverted by an unshown substrate inverting mechanism, thus causing a non-inspected back surface to face upward and to be subjected to the same inspection as the front surface is subjected to, whereby the both surfaces of the sample can be subjected to the inspection.

On the other hand, in the simulation system 150, the defect model which is generated on the type, shape, and size of the defect which is previously estimated by the model generation means 151. Next, in the output calculation means 152, a distribution of reflected and scattered light, in case where light having the same angle, wavelength, and output as the irradiation light from the illumination means 110 of the optical system 100 has enters, is calculated and the respective detector signal outputs, which correspond to a case where light collection and detection are performed in the high angle detection means 120 and low angle detection means 130 of the optical system 100, are calculated. The results are accumulated in the defect signal output data base 153, and combinations of respective defect models and estimated detector outputs corresponding thereto are stored.

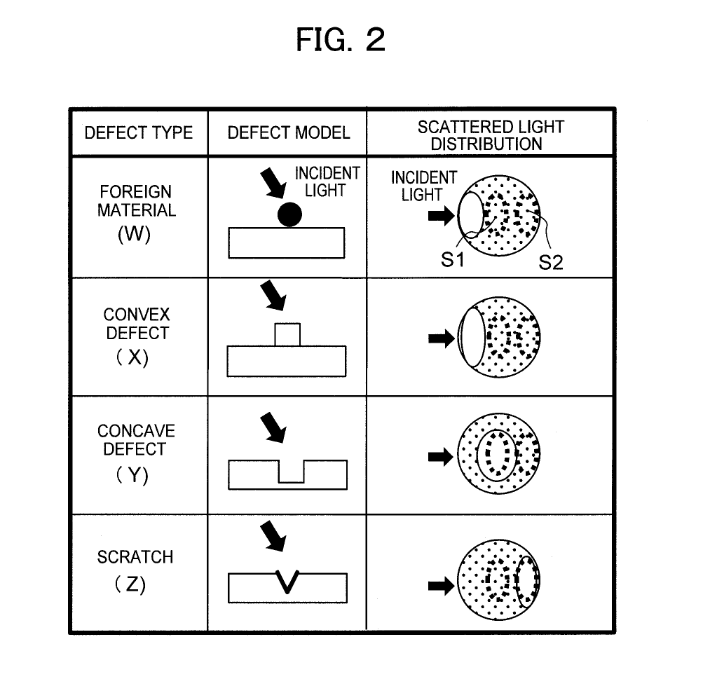

Referring to FIG. 2, these processes will be explained in detail. A table of FIG. 2 shows examples of the defect models which are generated by the model generation means 151, and the light distribution 3 of the reflected and scattered light which is calculated by the output calculation means 152. For example, foreign material, a convex defect, a concave defect, and scratch are assumed as the defect models. The respective defect models (sectional views) are generated as shown in FIG. 2. The illustrated defect models are typical examples and have variations such as changes in size.

A scattered light distribution, in a case where incident light is illuminated onto these defect models under the same conditions as the illumination light from the illumination means 110 of the optical system 100 is done, is calculated by the output calculation means 152. As the calculation method, it is based on Rayleigh scattering and Mie scattering theories which are generally used. In the scattered light distribution in the table of FIG. 2, light intensity distributions as viewed from top surface directions of the defect models are shown as light and shade. In FIG. 2, the light and shade are clearly defined. However, in fact, they are gradually changed.

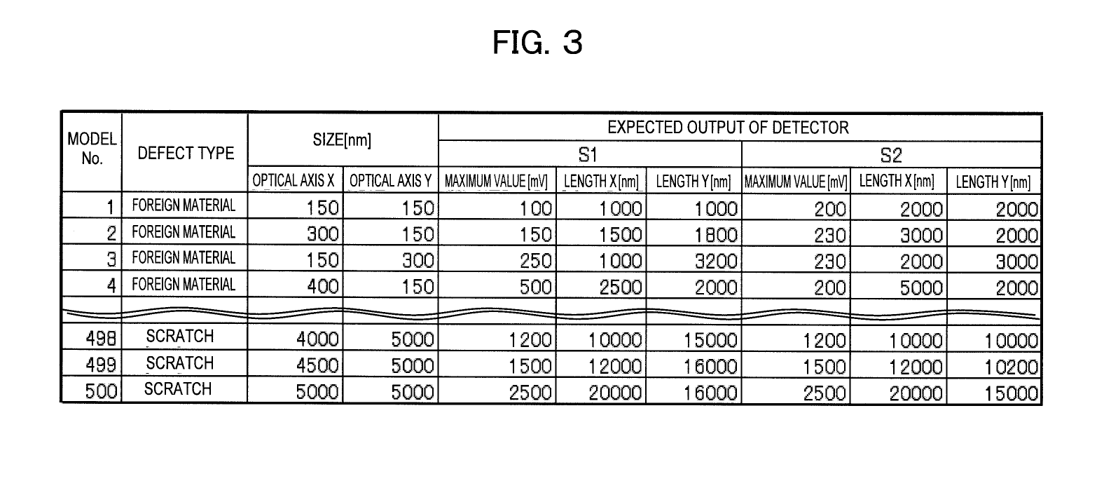

From such intensity distributions, detector outputs are calculated as a total intensity S1 of a region corresponding to the high angle detection means 120 of the optical system 100 and as a total intensity S2 of a region corresponding to the low angle detection means 130. The respective defect models and examples of calculation results with respect to sizes are shown in FIG. 3. FIG. 3 shows an estimate of S1 and S2 signal outputs in the respective defect types and sizes. In addition to maximum output values of the signals, detection sizes of the scattered light from the disc surface with respect to the incident light are calculated as an X-direction length and a Y-direction length. Incidentally, the illumination light from the illumination means 110 of the optical system 100 straightly moves along a diametrical center line on the sample disc as the sample is turned, so that the X-direction length corresponds to a diametrical direction length and the Y-direction length corresponds to a circumferential direction length. Such expected detector outputs are accumulated in the defect signal output data base 153.

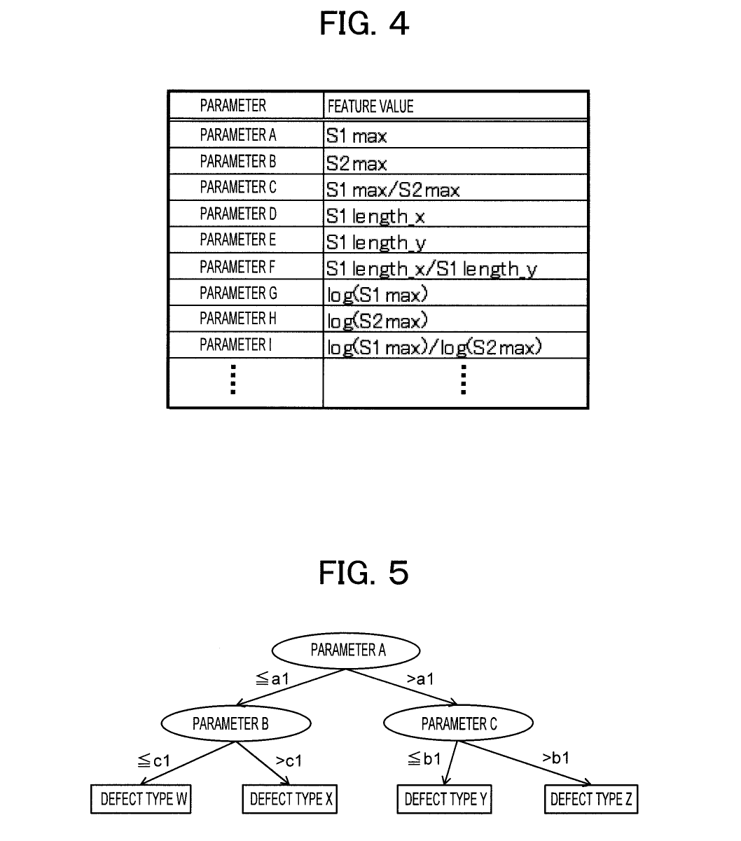

The defect classifying and processing system 160 performs the defect classification on the basis of the output from the signal processing device 6 and the data from the detect signal output data base 153. Referring to FIGS. 4 to 7, the process by the defect classifier 161 will be explained.

First of all, feature values are calculated from the respective signals obtained by the detect signal output data base 153. FIG. 4 illustrates examples of the feature values. The feature values are set to signals themselves or calculation values among the signals, logarithm values, etc., as parameters A, B, C . . . . Mechanical classification is performed based on these feature value parameters and the defect types, to thereby construct such a classifier as to be shown in FIG. 5, for example. The example process shown in FIG. 5 is called a decision tree classification whose decision algorithm is generally known. The classification results are determined according to values of set values a1, b1, c1 of the respective parameters.

By employing such a simulation configuration, it is possible to obtain combinations of the detector outputs in assumed defects. However, defect models which can be calculated by utilizing present computer capability are simple shapes such as globular shapes, evenly convex and concave shapes, etc. , so that it has been found that they are deviated from the detector outputs in the actual defects.

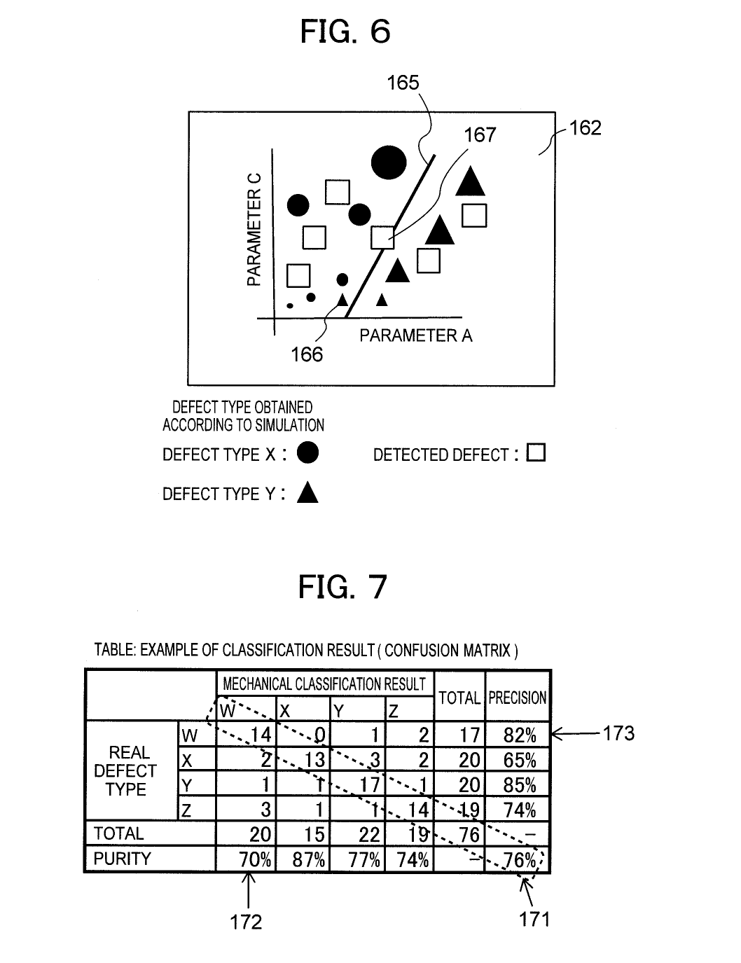

Next, the classification results obtained in the defect classifier 161 are displayed on the feature value displaying screen 162 and the parameters and the distribution state of the defect classification are displayed on the screen. In FIG. 6, its examples are shown. Distribution states of defect species X () and defect species (▴) are obtained in the simulation with respect to the parameters A, C. The sizes of the defects are illustrated by the sizes of the marks. Defects X, Y are substantially discriminated by a distinction line 165 set in the defect classifier 161. However, a defect 166 whose size is small is erroneously judged. The simulation data is known in its shape size, so that it is possible to grasp a shape size of classification limit.

Moreover, the feature values are calculated on the basis of the output from the signal processing device 6 and plotted as detected defects (□) on the feature value displaying screen 162. By processing in this way, locations of the detected defects in a feature value space are come to light . Next, the type of the detected defects (□) is confirmed by other means such as the microscope 170. The detected defects are the actual defects that are detected utilizing the optical system 100, so that the locations of the defects on the samples 1 are easily discovered by confirming the defect position displaying screen 163. At this time, it is unnecessary to observe all the detected defects (□) and, for example, a detected defect 167 adjacent to the distinction line 165 is preferentially observed

In this way, the detected defects are successively confirmed with respect to other parameter-setting values and defect types, and the feature value distribution of the actually detected defects are obtained. When confirmation of the defect types of a fixed amount of the actually detected defects is completed, the mechanical classification is again performed by the detect classifier 161 and the set values are renewed. At this time, the renewal of the set values may be repeated while confirming a defect classification performance which is called a confusion matrix. An example of the confusion matrix in which types of defect are four (W, X, Y, and Z) and the total number of samples is 76 is shown as a table in FIG. 7. The table in which results obtained by performing the mechanical classification with respect to the actual defect species are collected per defect species, and it shows the classification performance. For example, the entire classification performance is obtained by dividing a sum of the number of samples, in which the actual defect species and the mechanical classification results agree with each other, by the total number of the samples. In FIG. 7, 76% which are obtained by dividing 58 by 76 exhibits the classification performance. 58 is the sum of W, X, Y, and Z in an oblique component 171. Moreover, the number of samples mechanically classified as the defects W in a vertical component 172 is 20, among which X:2, Y:1, and Z:3 are erroneously judged, and purity of the classification is as follows: 14/20=70%. Moreover, there were 17 samples having the actual W defects in a horizontal component 173 but samples which were judged as W by the mechanical classification were 14 samples, so that classification precision is as follows: 14/17=82%.

By considering the actual defect as the sample and confirming such evaluation results, it is possible to efficiently obtain desired classification performance corresponding to fatality of the defect.

After the desired classification performance is confirmed in this way and the classifier is constructed, inspection and classification are performed.

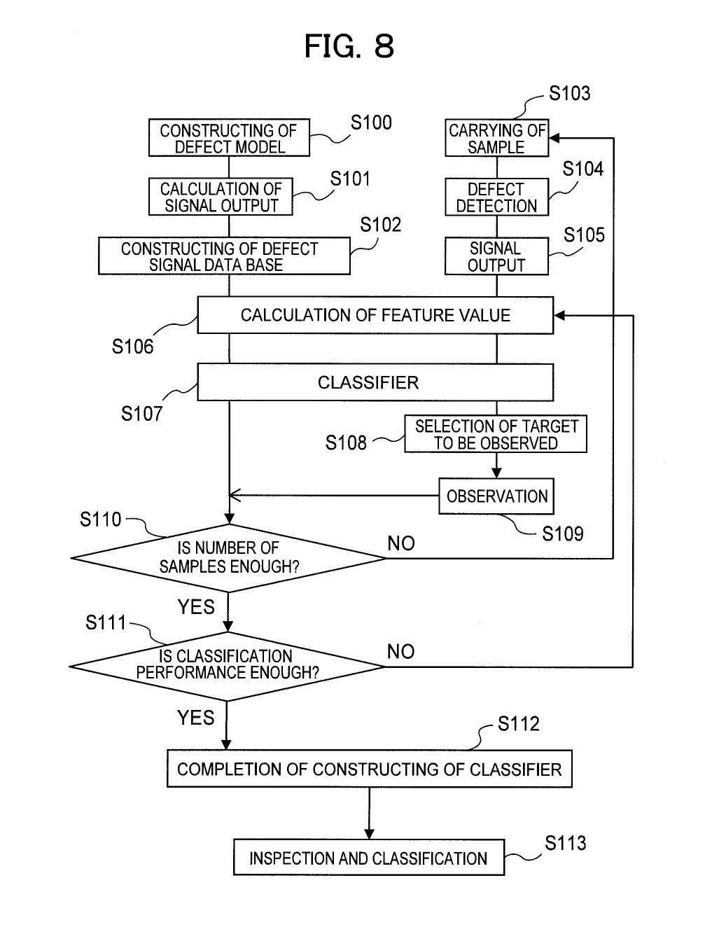

Referring to FIG. 8, the flow of the actual inspection and classification process will be explained.

First of all, as already described, in the simulation system 150, the constructing of the defect signal data base (S102) is performed by the constructing of the defect models (S100) and the calculation of the signal outputs (S101). The feature value is calculated on the basis of the data (S106) and an initial classifier is constructed (S107). Next, an actual sample is installed in the optical system 100 (S103), the defect detection is performed (S104), and the signal output corresponding to the defect is obtained (S105). On the basis of the classification result obtained with reference to the actual sample by the calculation of the feature value and the classifier that is already constructed, an inspection target is selected (S108). The actual defect is observed by a means such as a microscope (S109) and the defect type is confirmed. Until the number of observed samples becomes enough, the observation of the defect is repeated. However, in the selection of the target (S108), a sample which has a feature value close to a classification judgment formula is selected, whereby it is possible to realize efficient sample observation. In a case where the number of the sample is enough (S110), if the observation of, for example, ten or more samples is completed per defect type, classification performance is confirmed, and the classification performance is evaluated as an index such as classification precision (S111). In a case where the classification performance is not enough, the process is again returned to the step of the calculation of the feature value, and the classification performance is evaluated by selection of the parameter and review of the set value of the classifier, for example. In a case where the classification performance is enough, the classifier constructing is finished (S112), and inspection and defect classification of the actual inspection sample are performed (S113).

Incidentally, while in this embodiment, the number of the detectors installed in the optical system 100 is two and they are arranged on the same plane, they may be arranged on different planes, for example, in consideration of the distribution of the scattered light. Moreover, of course, three or more detectors may be employed.

Moreover, the optical system is not limited to the scattered light detection optical system and may be configured, for example, as an optical system including an optical lever for detecting the surface roughness, a position sensor, etc.

Moreover, the data base of the various defects and signal outputs which is found by the simulation system may be constructed utilizing the defect samples which are actually detected utilizing the optical system 100. If the number of the defect samples is enough as the initial value, of course, it may be employed in lieu of them.

Although the present invention made by the inventor have been concretely explained with reference to the embodiment, it is readily understood that the present invention is not limited to the embodiment and that various modifications and changes can be made by those skilled in the art without departing from the spirit and scope of the present invention.

What is claimed is:

1. A substrate surface defect inspection device comprising:
a turnable stage means on which a substrate that is an inspection target is carried;
an inspection optical system including one or more illumination sources irradiating light onto the substrate carried on the stage means, and one or more detectors detecting reflected and scattered light from the substrate onto which the light is irradiated by the illumination sources;
an A/D converter means amplifying and A/D converting signals outputted from the one or more detectors of the inspection optical system;
a defect detection means processing the signals, which are outputted from the one or more detectors and converted by the A/D converter, and detecting a defect on the substrate; and
a defect classification means classifying the defect on the basis of the signals outputted from the one or more detectors;
wherein the defect classification means is adapted to correct a classification parameter utilizing a detection signal for an actual sample, after determining the classification parameter by simulation.

2. The substrate surface defect inspection device according to claim 1, wherein selection of the actual sample handled by the defect classification means is performed in such a manner that a sample adjacent to a boundary of defect classification is preferentially selected.

3. The substrate surface defect inspection device according to claim 1, wherein the correction of the classification parameter by the defect classification means is performed in such a manner to successively change a classification judgment formula so as to obtain desired classification performance.

4. A substrate surface defect inspection device comprising:
a turnable stage means on which a substrate that is an inspection target is carried;
an inspection optical system including one or more illumination sources irradiating light onto the substrate carried on the stage means, and one or more detectors detecting reflected and scattered light from the substrate onto which the light is irradiated by the illumination sources;
an A/D converter means amplifying and A/D converting signals outputted from the one or more detectors of the inspection optical system;
a defect detection means processing the signals, which are outputted from the one or more detectors and converted by the A/D converter, and detecting a defect on the substrate; and
a defect classification means classifying the defect on the basis of the signals outputted from the one or more detectors;
wherein the defect classification means is adapted to correct a classification parameter utilizing a detection signal for a specific defect sample adjacent to a classification boundary, after determining the classification parameter using an initial defect sample.

5. The substrate surface defect inspection device according to claim 4, wherein the correction of the classification parameter by the defect classification means is performed in such a manner to successively change a classification judgment formula so as to obtain desired classification performance.

6. A substrate surface defect inspection device comprising:
a turnable stage means on which a substrate that is an inspection target is carried;
an inspection optical system including one or more illumination sources irradiating light onto the substrate carried on the stage means, and one or more detectors detecting reflected and scattered light from the substrate onto which the light is irradiated by the illumination sources;
an AID converter means amplifying and AID converting signals outputted from the one or more detectors of the inspection optical system;
a defect detection means processing the signals, which are outputted from the one or more detectors and converted by the A/D converter, and detecting a defect on the substrate; and
a defect classification means classifying the defect on the basis of the signals outputted from the one or more detectors;
wherein the defect classification means is adapted to present a defect size and a classification limitation on a classification type by simulation and correct a classification parameter for an actual sample.

7. The substrate surface defect inspection device according to claim 6, wherein the correction of the classification parameter by the defect classification means is performed in such a manner to successively change a classification judgment formula so as to obtain desired classification performance.

8. A substrate surface defect inspection method comprising the steps of:
irradiating illumination light from one or more illumination sources onto a substrate carried on a turnable stage, while turning the turnable state;
detecting, by one or more detectors, reflected and scattered light from the substrate onto which the light is irradiated by the one or more illumination sources;
amplifying and A/D converting signals that are outputted from the one or more detectors that detect the reflected and scattered light from the substrate;
processing the signals, that are outputted from the one or more detectors and A/D converted, and detecting a defect on the substrate; and
classifying the detected defect;
wherein the step of classifying a defect includes the step of correcting a classification parameter utilizing a detection signal for an actual sample, after determining the classification parameter by simulation.

9. The substrate surface defect inspection method according to claim 8, wherein the step of classifying a defect includes the step of performing selection of the actual sample in such a manner to preferentially select a sample adjacent to a boundary of defect classification.

10. The substrate surface defect inspection method according to claim 8, wherein the step of classifying a defect includes the step of successively changing a classification judgment formula so as to obtain desired classification performance.

11. A substrate surface defect inspection method comprising the steps of:
irradiating illumination light from one or more illumination sources onto a substrate carried on a turnable stage, while turning the turnable state;
detecting, by one or more detectors, reflected and scattered light from the substrate onto which the light is irradiated by the one or more illumination sources;
amplifying and A/D converting signals that are outputted from the one or more detectors that detect the reflected and scattered light from the substrate;
processing the signals, that are outputted from the one or more detectors and A/D converted, and detecting a defect on the substrate; and
classifying the detected defect;
wherein the step of classifying a defect includes the step of correcting a classification parameter utilizing a detection signal for a specific defect sample adjacent to a classification boundary, after determining the classification parameter using an initial defect sample.

12. The substrate surface defect inspection method according to claim 11, wherein the step of correcting a classification parameter includes the step of successively changing a classification judgment formula so as to obtain desired classification performance.

13. A substrate surface defect inspection method comprising the steps of:
irradiating illumination light from one or more illumination sources onto a substrate carried on a turnable stage, while turning the turnable state;
detecting, by one or more detectors, reflected and scattered light from the substrate onto which the light is irradiated by the one or more illumination sources;
amplifying and A/D converting signals that are outputted from the one or more detectors that detect the reflected and scattered light from the substrate;
processing the signals, that are outputted from the one or more detectors and A/D converted, and detecting a defect on the substrate; and
classifying the detected defect;
wherein the step of classifying a defect includes the step of presenting a defect size and a classification limitation on a classification type by simulation and correcting a classification parameter for an actual sample.

14. The substrate surface defect inspection method according to claim 13, wherein the step of correcting a classification parameter includes the step of successively changing a classification judgment formula so as to obtain desired classification performance.
